(19) United States
(12) Patent Application Publication
(10) Pub. No.: US 2004/0148608 A1
(43) Pub. Date: Jul. 29, 2004

(54) Portable executable software architecture

(76) Inventors: James K. Gendreau, Fremont, CA (US); Ravikumar Pisupati, San Jose, CA (US)

Correspondence Address: HEWLETT-PACKARD COMPANY, Intellectual Property Administration, P.O. Box 272400, Fort Collins, CO, 80527-2400, US

(21) Appl. No.: 10/350,090

(22) Filed: Jan. 24, 2003

(51) Int. Cl. G06F 9/00

(52) U.S. Cl. 719/310

(57) ABSTRACT

A portable executable software architecture including a virtual machine, preferably JAVA-based, a web browser, a web application server, and one or more applications. The web application server and the one or more applications execute on the virtual machine. The web application server transmits data to the web browser for display to the user, and the web browser transmits information to the web application server representing user interaction with the web browser. Responsive to information received from the web browser, one or more applications executing on the virtual machine and communicating with the web application server generate the data transmitted by the web application server to the web browser. The one of more applications receive the information transmitted by the web browser and display the information to the user.

### RELATED APPLICATIONS

This application is related to co-pending applications entitled, “Single System for Managing Multi-platform Data Retrieval” (HP Reference 100204177-1); “Compressed Data Structure for a Database” (HP Reference 100204178-1); “Compressed Data Structure for Extracted Changes to a Database and Method of Generating the Data Structure” (HP Reference 100204180-1); and “Method of Updating Data in a Compressed Data Structure” (HP Reference 200207707-1), all assigned to the present assignee, all of which are hereby incorporated by reference in their entirety, and all of which are being filed concurrently herewith. This application is also related to co-pending applications entitled, “E-service to Manage and Export Contact Information” (HP Reference 10992821-1), Ser. No. 09/507,043 filed Feb. 18, 2000; “E-Service to Manage Contact Information and Signature Ecards” (HP Reference 10992671-1), Ser. No. 09/507,631 filed Feb. 18, 2000; “E-service to Manage Contact Information and Track Contact Location” (HP Reference 10992821-1), Ser. No. 09/507,043 filed Feb. 18, 2000; and “E-service to Manage Contact Information with Privacy Levels” (HP Reference 10992822-1), Ser. No. 09/507,215 filed Feb. 18, 2000, all assigned to the present assignee, and all of which are hereby incorporated by reference in their entirety.

### FIELD OF THE INVENTION

The present invention is related to portable executable software capable of execution by multiple different computer hardware systems. More specifically, the present invention is related to portable executable software having a non-hardware-specific display interface.

### BACKGROUND

Computers are complex systems made up of numerous components, e.g. executable software and hardware components for executing the software. Executable software components include operating systems, device drivers, and software applications. Protocols specify how two or more components communicate. Because of the multitude of hardware and software component designs and manufacturers, many components are incompatible. For example, the majority of software applications are specific to a particular operating system and are not executable by another operating system. Even if the underlying source code is generalized sufficiently to be compiled for different operating systems, the resulting software application cannot be transferred from one operating system to another without requiring a compilation of the source code for the new operating system.

Designers of executable software for a specific operating system must bear this situation in mind when designing and writing executable software applications. One approach is to create software applications for execution by a single particular operating system, such as WINDOWS 2000 available from Microsoft Corp. In this approach, the software application will not be portable to other operating systems, for example, operating system-specific software applications designed for execution by a WINDOWS 2000 operating system is not executable by a MACINTOSH operating system available from Apple Computer, Inc., and vice versa.

Another approach is to design software applications to utilize an intermediate executable software component providing an interface between the software application and the operating system. The most common example of an intermediate component is a virtual machine, for example a JAVA virtual machine (JAVA VM or JVM). JAVA is available from Sun Microsystems. While a JAVA VM must be tailor-written specific to an operating system, JAVA language-based software applications are executable by any JAVA VM irrespective of the underlying operating system. The disadvantage of this approach is that the software application is dependent on the JVM to interface with the operating system and can not access functionality not provided by the JVM. For example, the JVM may not provide a JAVA-based software application access to certain low-level networking capabilities provided by the operating system, which would be accessible to operating system specific software applications.

Desktop and laptop computers are less affected by component compatibility than handheld, sometimes referred to as personal digital assistants (PDAs), or embedded devices. Desktop and laptop computers benefit from the tremendous market share that Microsoft and Intel exercise in the operating system and processor markets, respectively. Software developers designing software applications for computers using Microsoft operating systems and Intel processors may be confident that their software applications are compatible with the computer. Microsoft and Intel have imposed a de facto standard functionality on all hardware designed to work with their components, i.e. Microsoft operating systems and Intel processors. In particular, all graphics chips must implement a certain minimum functionality ensuring that software application developers creating software applications for Microsoft operating systems need not worry about the particulars of the underlying graphics hardware the software application accesses to display an interface to a user. The developer may choose to take advantage of an additional feature offered by a particular graphics chip, but a computer without that particular graphics chip will be unable to execute the software application and take advantage of the particular feature.

The handheld or embedded device market includes a number of different computers from different manufacturers using different operating systems and hardware components. Partly due to characteristics of the handheld market, and partly due to characteristics of handheld technology, each handheld device may use graphics chips having significantly different capabilities. Even within handheld devices from the same manufacturer, different capabilities are present. Handheld device operating systems present a similar challenge to software application developers. Often, the handheld device operating system capabilities differ for different handheld devices. A particular operating system and hardware component combination is known as a platform, e.g. WINDOWS CE operating system on a Hewlett-Packard JORNADO handheld device.

Platform-specific applications, sometimes referred to as native applications, written for one handheld device platform will not work on another handheld device platform. Two different models of the same handheld device platform line, or an older and newer version of the same model, may even be considered different platforms for the purposes of software compatibility. Because WINDOWS CE is not a single operating system, but rather a collection of interoperating executable software modules selected for a particular platform, the software incompatibility still exists even if both models are running on the “same” operating system.

One prior approach to improving compatibility is to create software applications using the JAVA language. The software applications are interpreted by a JVM executing on the handheld device. However, because of the great variability in display mechanisms, in particular graphics devices, across handheld platforms, even a JVM is unable to provide a portable interface to the graphics hardware. In desktop and laptop computers, a common set of display interfaces for JAVA-based software applications may be accessed using a common graphic display package, such as AWT and Swing. JVMs are not required to provide swing type capability and therefore, handhelds do not provide such a built-in capability.

Further, the choice of platform for desktop and laptop computers purchased by a company is typically made by an Information Technology (IT) department. Typically, the IT department will choose to have a single computing platform for an entire company, or for entire corporate divisions to attempt to simplify management and support of computing issues, including purchase, upgrade, and support of executable software.

In contrast to desktop and laptop computers, handheld devices are typically regarded as an expense item, and are not managed by the IT department. As a result, dozens of different, and incompatible, handheld device platforms may be used within a single company or even within a single corporate division. Because of the differing platforms, deploying a single handheld device software application to the entire company or corporate division is nearly impossible. Multiple individual device-specific applications need to be purchased and installed on the different platforms. A portable executable software architecture, according to which a software application could run on any handheld device, would enable an IT department to deploy the software application to any number of users, without having to worry about the requirements of specific handheld devices.

### SUMMARY

It is, therefore, an object of the present invention to provide a portable executable software architecture, according to which a software application can run on any handheld device, regardless of the device's graphics hardware.

Another object of the present invention is to ease deployment of a software application to multiple handheld devices.

This and other objects of the present invention are achieved by a portable software architecture, according to which an application can run on any computer platform, irrespective of the platform's graphics hardware. The portable software architecture comprises a virtual machine, a web browser, a web application server running on the virtual machine, and one or more applications executed by the web application server, also running on the virtual machine. The one or more applications generate data which the web application server serves to the web browser.

Still other aspects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention.

### DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a high level block diagram of an example computer on which an embodiment of the present invention may be executed;

FIG. 2 is a block diagram of a high level form of a portable executable software architecture according to an embodiment of the present invention; and

FIG. 3 is a block diagram of a particular software application according to the portable executable software architecture according to an embodiment of the present invention.

### DEFINITIONS

Web browser—an application which reads one or more web languages (typically all web browsers are capable of reading HTML), and generates a display accordingly. Most web languages are either mark-up languages or scripting languages. Web browsers further possess the ability to communicate over a network by means of protocols, such as hypertext transfer protocol (HTTP).

Native—utilizing a platform directly, without an intermediate level such as the JAVA VM.

Platform—the composite of the hardware and operating system of a computer, which determines the compatibility of a given software application with that computer.

Handheld device (also referred to as a PDA—a small computer, generally about the size of an adult's hand, designed to be carried and used while running on battery power.

HTML—hypertext markup language specifying the layout and content of a web page.

HTTP—a protocol specifying the transfer of HTML information.

### DETAILED DESCRIPTION

A portable executable software architecture, according to which a software application can run on any computing device is described. In the following description, for purposes of explanation, numerous specific details are set forth in order to provide a thorough understanding of the present invention. It will be apparent, however, that the present invention may be practiced without these specific details.

In a preferred embodiment of the present invention, the portable executable software architecture is used for software applications-running on a handheld device. However, those skilled in the art will appreciate that the software architecture can be used for software applications running on any computing device meeting the requirements specified below.

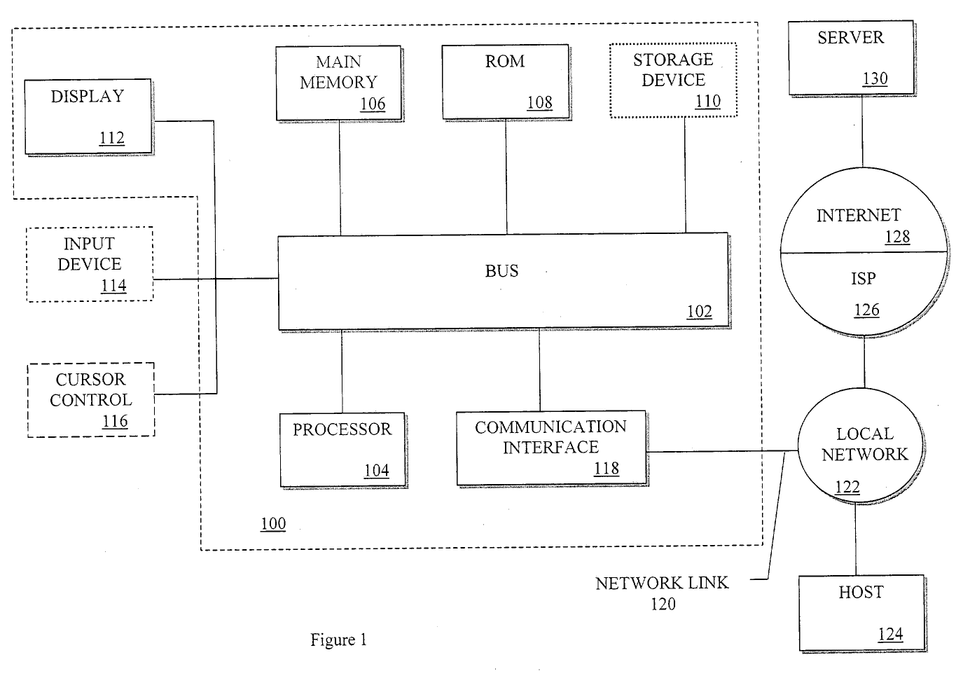

FIG. 1 is a block diagram illustrating an exemplary computer 100, e.g. a handheld device, upon which an embodiment of the invention may be implemented. The present invention is usable with currently available handheld and embedded devices, and is also applicable to personal computers, mini-mainframes and the like.

Computer 100 includes a bus 102 or other communication mechanism for communicating information, and a processor 104 coupled with the bus 102 for processing information. Computer 100 also includes a main memory 106, such as a random access memory (RAM) or other dynamic storage device, coupled to the bus 102 for storing transaction and interaction data, and instructions to be executed by processor 104. Main memory 106 also may be used for storing temporary variables or other intermediate information during execution of instructions to be executed by processor 104. Computer 100 further includes a read only memory (ROM) 108 or other static storage device coupled to the bus 102 for storing static information and instructions for the processor 104. A storage device 110 (dotted line), such as a compact flash, smart media, or other storage device, is optionally provided and coupled to the bus 102 for storing instructions.

Computer 100 may be coupled via the bus 102 to a display 112, such as a flat panel touch-sensitive display, for displaying an interface to a user. In order to reduce space requirements for handheld devices, the display 112 typically includes the ability to receive input from an input device, such as a stylus, in the form of user manipulation of the input device on a sensing surface of the display 112. An optional input device 114 (dash dot line), such as a keyboard including alphanumeric and function keys, is optionally coupled to the bus 102 for communicating information and command selections to the processor 104. Another type of optional user input device is cursor control 116 (long dash line), such as a stylus, pen, mouse, a trackball, or cursor direction keys for communicating direction information and command selections to processor 104 and for controlling cursor movement on the display 112. This input device typically has two degrees of freedom in two axes, a first axis (e.g., x) and a second axis (e.g., y) allowing the device to specify positions in a plane.

The invention is related to the use of computer 100, such as the depicted computer of FIG. 1, to execute a portable software application. According to one embodiment of the invention, the portable software application is executed by computer 100 in response to processor 104 executing sequences of instructions contained in main memory 106 in response to input received via input device 114, cursor control 116, or communication interface 118. Such instructions may be read into main memory 106 from another computer-readable medium, such as storage device 110. A user interacts with the portable software application via a user interface displayed (as described below) on display 112.

However, the computer-readable medium is not limited to devices such as storage device 110. For example, the computer-readable medium may include a floppy disk, a flexible disk, hard disk, magnetic tape, or any other magnetic medium, a compact disc-read only memory (CD-ROM), any other optical medium, punch cards, paper tape, any other physical medium with patterns of holes, a random access memory (RAM), a programmable read only memory (PROM), an erasable PROM (EPROM), a Flash-EPROM, any other memory chip or cartridge, a carrier wave embodied in an electrical, electromagnetic, infrared, or optical signal, or any other medium from which a computer can read. Execution of the sequences of instructions contained in the main memory 106 causes the processor 104 to perform the process steps described below. In alternative embodiments, hard-wired circuitry may be used in place of or in combination with computer software instructions to implement the invention. Thus, embodiments of the invention are not limited to any specific combination of hardware circuitry and software.

Computer 100 also includes a communication interface 118 coupled to the bus 102 and providing two-way data communication as is known in the art. For example, communication interface 118 may be an integrated services digital network (ISDN) card, a digital subscriber line (DSL) card, or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals which carry digital data streams representing various types of information. Of particular note, the communications through interface 118 may permit transmission or receipt of instructions and data for execution of the software application. For example, two or more computers 100 may be networked together in a conventional manner with each using the communication interface 118.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the “Internet” 128. Local network 122 and Internet 128 both use electrical, electromagnetic or optical signals which carry digital data streams. The signals through the various networks and the signals on network link 120 and through communication interface 118, which carry the digital data to and from computer 100, are exemplary forms of carrier waves transporting the information.

Computer 100 can send messages and receive data, including program code, through the network(s), network link 120 and communication interface 118. In the Internet example, a server 130 might transmit a requested code for an application program through Internet 128, ISP 126, local network 122 and communication interface 118. In accordance with the invention, one such downloaded application conforms to a portable executable software architecture in accordance with an embodiment of the present invention.

The received code may be executed by processor 104 as it is received, and/or stored in storage device 110, or other non-volatile storage for later execution. In this manner, computer 100 may obtain application code in the form of a carrier wave.

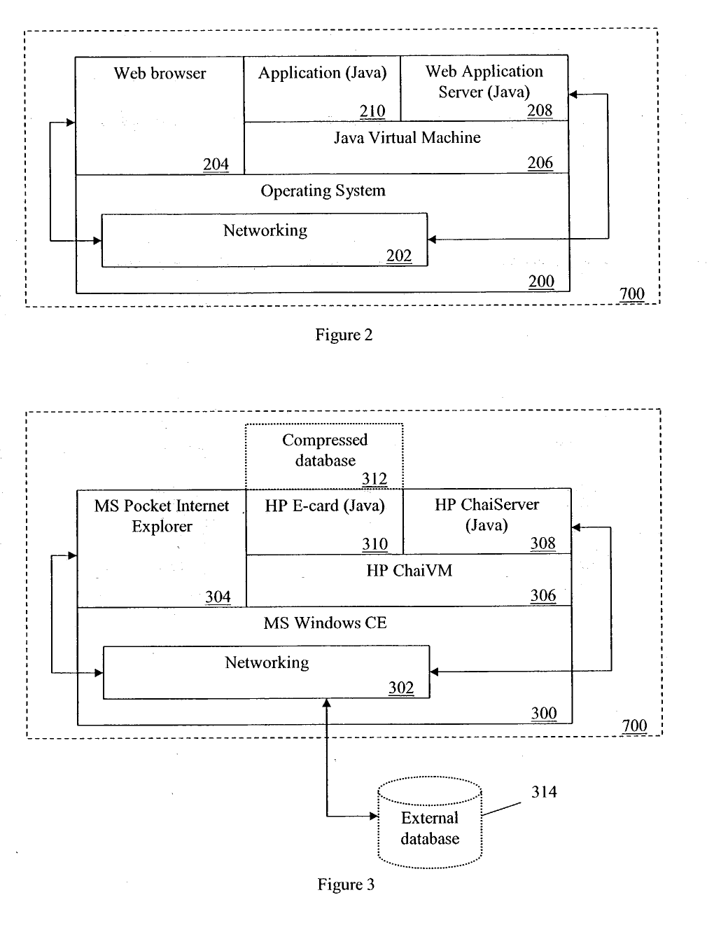

Referring now to FIG. 2, a high level block diagram depicts a portable software architecture according to the present invention. A computer 100 includes an operating system 200, stored in ROM 108 and main memory 106, having a networking component 202. The processor 104 executes operating system 200 instructions from memory 106 and/or ROM 108. Instructions for a web browser 204, as is known in the art, are executed by the processor 104 and access functionality provided by the operating system 200 including functionality of networking component 202. Although web browser 204 is shown and described as a native software application, it is to be understood that in alternate embodiments web browser 204 can be a JAVA-based web browser executing on a JVM. Web browser 204 is a display and input interface for the user, i.e. the browser window is used to present information to the user and the same window is used to receive input from the user in the form of buttons, checkboxes, input fields, forms, etc.

Virtual machine 206 instructions are executed by processor 104 and cause the processor to access functionality provided by the operating system 200, e.g. function calls or method invocations. Virtual machine 206 executes a web application server 208 instructions to provide application serving functionality. In particular, web application server 208 executes application 210 instructions in response to HTTP requests received by the web application server 208 from networking component 202. The application 210, interacting with the user through the portable executable software architecture of the present invention, provides the functionality requested by the user. For example, the application 210 may be a personal information management (PIM) software application managing contacts and related information for a user. The application 210 may be any software application desired by the user subject to memory and processing capability.

According to an embodiment of the present invention, the application 210 is the only component of the software architecture which must be customized for each specific application. That is, it is not necessary to customize the application for a particular processor, graphics interface device, or other computer hardware. The user interface displayed to the user for interacting with the application 210 is displayed by the web browser 204. The user interface, i.e. web browser 204, and the application 210 communicate using standard networking protocols, such as HTTP. HTTP requests and responses communicated between the web browser 204 and the application 210, are sent via the built-in networking component 202 of the operating system 200, using the same networking protocols that web browser 204 and application 210 would use if they were communicating over a network between different computing devices. Typically, the network protocol used is TCP/IP, but those skilled in the art will appreciate that other networking protocols could be substituted.

The application 210 does not send or receive networking messages directly, but rather the web application server 208 acts as a proxy and manages all network communication between the application 210 and the web browser 204. The web application server 208 and application 210 communicate via standard virtual machine language methods known to those skilled in the art.

When a user causes execution of the software application designed using the software architecture of the present invention, an HTTP request is transmitted to the web application server 208 via networking component 202 to begin execution of the application 210. In response to the HTTP request received from the web browser 204, the web application server 208 executes application 210 and transmits an HTTP response, containing the output of the application 210, via networking component 202 to the web browser 204. Typically, the output from application 210 will be in HTML, but any other web markup and/or layout language can be used.

All further interaction between the user and the application 210 is handled in the same manner, that is, the user interacts with the user interface as displayed by the web browser 204. Commands generated as a result of the user interacting with the display of the web browser 204 are translated into HTTP requests according to methods known to persons skilled in the art, and these requests are sent to the application 210 via networking component 202. The application 210 processes the received HTTP requests, and generates a response to send back to the web browser 204, thus continuing the user interface cycle. The application 210 response is sent back to the web browser 204, encapsulated within an HTTP response.

Alternatively, the web browser 204 and the application 210 could communicate using a standard networking protocol other than HTTP. Also alternatively, the application 210 could send its output to the web browser 204 using a display language other than HTML, e.g. user interface markup language (UIML), extensible markup language (XML), wireless markup language (WML), handheld device markup language (HDML), etc.

Having been designed according to the software architecture of the present invention, the application 210 is fully portable to another computer having a virtual machine 206, a native web browser 204, and an operating system 200 including a networking component 25. Each of the above components are typically standard on any computing device intended for direct human interaction, including desktops, laptops, and handheld or embedded devices. The application 210 will run on such a system regardless of the particular type of any of the abovementioned components, and regardless of the device display type.

It is well known to those skilled in the art that a single web application server 208 can execute a plurality of applications 210, and manage the network communication requirements of each application. One or more windows of the web browser 204 display the application 210 user interface to the user. A plurality of software applications designed according to the software architecture of the present invention, and running on a single computing device, can execute using a single web application server 210 and a plurality of windows displayed by the web browser 204.

Referring now to FIG. 3, a high level block diagram depicts an example of the portable software architecture of the present invention as applied to a particular software application, referred to as Mobile Ecardfile.

A handheld device 700 executes the WINDOWS CE operating system 300 which includes a networking component 302. Executing on the WINDOWS CE operating system 300 are MS Pocket Internet Explorer 304 and the HP ChaiVM JAVA virtual machine 306, a native web browser and a JAVA VM respectively. A Hewlett-Packard (HP) ChaiServer 308, a web application server, executes on HP ChaiVM JAVA VM 306 and responds to HTTP requests received by the HP ChaiServer server 308. A software application, HP E-card 310, is a JAVA application executing on the HP ChaiVM 306.

The handheld device 700 is a particular type of the computing device 700 in the high level block diagram of the portable executable software architecture of the present invention, depicted in FIG. 2. Similarly, the WINDOWS CE operating system 300 is a particular type of the operating system 200, for use on handheld devices; MS Pocket Internet Explorer 304 is a particular type of the native web browser 204, for use on handheld devices running WINDOWS CE; HP ChaiVM 306 is a particular type of the JAVA virtual machine 206, for use on handheld devices; HP ChaiServer 308 is a particular type of the web application server 208, for use on handheld devices; and HP E-card 310 is a particular JAVA application 210.

Both HP ChaiServer 308 and the HP E-card application 310 are executed by the HP ChaiVM JAVA VM 306.

FIG. 3 also includes a compressed database 312 (dotted line) for storing data accessed by the HP E-card application 310. The compressed database 312 is optional and is utilized by the example software application of FIG. 3. The compressed database 312 is described in further detail in co-pending applications entitled, “Unified Service to Manage Multi-Platform Data Retrieval,” “Compressed Data Structure for Extracted Changes to a Database,” “Compressed Data Structure for a Database,” and “Method of Updating a Compressed Data Structure,” all assigned to the present assignee, and all of which are hereby incorporated by reference in their entirety.

It will be appreciated by those skilled in the art that a software application designed using the portable executable software architecture of the present invention can interact with any external data sources or applications without affecting the nature of the invention. Another example of an external data source is a remote server accessed over a network, generally represented by the reference numeral 314 (dotted line) in FIG. 3.

To execute the HP E-card application 3 10, the user clicks on an icon, selects a menu option, or otherwise manipulates an element of the user interface of device 700, according to built-in methods provided by the WINDOWS CE operating system 300. Any known methods provided by the WINDOWS CE operating system for causing execution of a program may be used.

Initiation of execution of application 310 causes the application to transmit an HTTP request to HP ChaiServer 308 via networking component 302 to execute the HP E-card application 310. The HP E-card application 310 then transmits an HTTP response containing HTML representing the user interface for the E-card application 310 to the MS Pocket Internet Explorer 304. The MS Pocket Internet Explorer 304 receives, formats, and displays the HTML representing the user interface via display 112 to the user.

All communication between the E-card application 310 and the MS Pocket Internet Explorer 304 is sent via the networking component 302 to the HP ChaiServer 308. ChaiServer 308 receives and provides communication between the E-card application 310 and the MS Pocket Internet Explorer 304 via networking component 302.

When the user interacts with the user interface of the E-card application 310, as displayed by the MS Pocket Internet Explorer 304, the MS Pocket Internet Explorer 304 translates relevant user interaction into an HTTP request, which the MS Pocket Internet Explorer 304 then transmits to the E-card application 310, as described above. Examples of relevant user interaction include clicking on a hyperlink, submitting a form, etc. The types of relevant user interaction and the method of translating user interaction into HTTP requests are well known to those skilled in the art. The E-card application 310 receives the HTTP request, processes the request, and sends an HTTP response back to the MS Pocket Internet Explorer 304. All user interaction with E-card application 310 is handled in this manner.

It will be appreciated by those skilled in the art that the E-card application 310, by virtue of having been designed according to the executable software architecture of the present application, is portable to any handheld or other computing device having an operating system with a networking component, a web browser, and a JAVA virtual machine.

It should now be apparent that a portable software architecture has been described according to which a software application can run on any computing device, regardless of the device's hardware.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A portable executable software architecture, comprising:
a virtual machine;
a web browser;
a web application server transmitting data to the web browser, executing on the virtual machine, the web browser also transmitting information to the web application server representing user interaction with the web browser; and
one or more applications executing on the virtual machine and communicating with the web application server, wherein the one or more applications responsive to information received from the web browser generate the data which the web application server transmits to the web browser, and wherein the one or more applications receive the information transmitted by the web browser.

2. The architecture of claim 1, wherein the portable executable software is executed by a computer.

3. The architecture of claim 2, wherein the computer is a handheld device.

4. The architecture of claim 1, wherein the web browser displays the user-interface of the one or more applications, according to the data transmitted by the web application server.

5. The architecture of claim 1, wherein the web browser and web application server communicate via a networking component of an operating system.

6. The architecture of claim 1, wherein the data transmitted by the web application server to the web browser, and wherein the information transmitted by the web browser to the web application server, are transmitted using HTTP.

7. The architecture of claim 1, wherein the data transmitted by the web application server to the web browser is a mark-up language.

8. The architecture of claim 1, wherein the mark-up language is HTML.

9. The architecture of claim 1, wherein the virtual machine is a JAVA virtual machine.

10. The architecture of claim 1, wherein the web application server is JAVA language based.

11. The architecture of claim 1, wherein the one or more applications are JAVA language based.

12. A computer-readable medium comprising:
at least one sequence of machine executable instructions in machine form, wherein execution of the instructions by a computer causes the computer to:
execute a virtual machine;
execute a web browser for receiving input from a user and displaying information to the user;
execute a web application server on the virtual machine in communication with the web browser; and
execute an application on the virtual machine in communication with the web application server, wherein in response to user input from the web browser via the web application server the application generates data transmitted to the web application server for display to the user by the web browser.

13. The computer-readable medium of claim 12, wherein the computer is a handheld device.

14. The computer-readable medium of claim 12, wherein the web browser displays the user-interface of the application, according to the data transmitted by the web application server.

15. The computer-readable medium of claim 12, wherein the web browser and web application server communicate via a networking component of an operating system.

16. The computer-readable medium of claim 12, wherein the data transmitted between the web application server and the web browser are transmitted using HTTP.

17. The computer-readable medium of claim 12, wherein the data transmitted by the web application server to the web browser are a mark-up language.

18. The computer-readable medium of claim 17, wherein the mark-up language is HTML.

19. The computer-readable medium of claim 12, wherein the virtual machine is a JAVA virtual machine.

20. The computer-readable medium of claim 12, wherein the web application server is JAVA language based.

21. The computer-readable medium of claim 12, wherein the application is JAVA language based.

22. A computer system for executing software comprising:
a processor for receiving and transmitting data; and
a memory coupled to said processor, said memory having stored therein sequences of instructions which, when executed by said processor, cause said processor to execute a web browser and to execute an application on a virtual machine, wherein the application communicates with a web application server on the virtual machine, wherein the web application server communicates with the web browser, and wherein a user interacts with the application via interaction with the web browser communicated to the web application server and thereon communicated to the application.
